(19) United States
(12) Patent Application Publication
(10) Pub. No.: US 2020/0111033 A1
(43) Pub. Date: Apr. 9, 2020

(54) LEAD TIME DETERMINATIONS IN SUPPLY CHAIN ARCHITECTURE

(71) Applicant: Target Brands, Inc., Minneapolis, MN (US)

(72) Inventors: GAGAN MAHAJAN, Lakeville, MN (US); PRAVEEN KUMAR KUMARESEN, Minnetonka, MN (US); ABHILASH KONERI, Minneapolis, MN (US); KRAIG ` NARR, Stillwater, MN (US)

(21) Appl. No.: 16/150,935

(22) Filed: Oct. 3, 2018

(51) Int. Cl. G06Q 10/04; G06Q 10/08; G06Q 10/06

(52) U.S. Cl. CPC G06Q 10/04; G06Q 10/087; G06Q 10/0838; G06Q 10/0833; G06Q 10/06314

(57) ABSTRACT

A lead time architecture includes a lead time aggregator that calculates a lead time estimate to move products between a first node in a supply chain and a second node in the supply chain. The lead time aggregator can additionally, or alternatively, calculate lead time estimate for the sourcing of a product. This lead time estimate reflects the time between receipt of a purchase order by a vendor and the time of delivery of the ordered product to a node within the supply chain. The lead time aggregator is in communication with resources which provide the data upon which the lead time aggregator bases its calculations. The calculations can take into account expected times for route travel, warehouse, and supplier sourcing to be completed. The resources can include any of various resources that can provide insight into an accurate determination of lead times and can include, for example, a route travel time estimator, delivery schedules, sourcing time estimates, unloading schedules, warehousing time estimates and product-node relationship data.

### CROSS-REFERENCE TO RELATED APPLICATIONS

This application claims the benefit of U.S. Provisional Application No. 62/632,108 filed Feb. 19, 2018. This application is related by subject matter to co-pending U.S. Application No. ______ having Docket No.: 16386.0062US02|201801562.

### TECHNICAL FIELD

The present disclosure is directed to methods and systems for estimating lead time. More particularly, the present disclosure describes a system architecture for estimating sourcing lead times and node-to-node product transfer lead times in a supply chain architecture.

### BACKGROUND

Accurate lead times are an important factor in supply chain management. Whether it be a sourcing lead time (e.g., the amount time from receipt of a purchase order to receipt of the ordered product at a receiving node within the supply chain) or an inventory movement lead time (e.g., the amount of time to move product inventory between two or more nodes in a supply chain), an incorrectly estimated lead time can result in lost sales opportunities and a supply chain bloated with unmovable inventory. However, an accurately estimated lead time can result in a lean and agile inventory supply with optimal sales.

Existing attempts to calculate lead times for various sourcing events generally accommodate inputs from product sources, and calculate sourcing lead times for particular product fulfillment routes. However, such existing systems are ill-equipped to be incorporated into a real-time supply chain management system due at least in part to a lack of integration of such lead time calculations with the supply chain management system, and lack of concurrent coordination with demand forecasting and replenishment aspects of the supply chain management system.

### SUMMARY

In general terms, the present disclosure relates to a lead time architecture useful in generating accurate lead time estimates for supply chain management.

According to the present disclosure, a lead time architecture includes a lead time aggregator that calculates an estimate for a lead time to move product between a first node in a supply chain and a second node in the supply chain. The lead time aggregator can additionally, or alternatively, calculate an estimate for a lead time in sourcing a product that includes the time between receipt of a purchase order by a vendor and the time of delivery of the ordered product to a node within the supply chain. The lead time aggregator is in wired or wireless communication with a plurality of data resources which provide data used in the lead time calculations. The data resources can include any of various resources that can provide insight into the lead time needed to move a product between first and second nodes and/or from vendor to node. In certain examples disclosed herein the data resources can include one or more of a route travel time estimator, delivery schedules, sourcing time estimates, unloading schedules, warehousing time estimates, and product-node relationship data.

At least one aspect of the present disclosure is directed to a lead time estimating system. The lead time estimating system includes a processor and a memory device. The memory device contains instructions that when executed by the processor cause the processor to: (a) receive a route travel time estimate, the estimated route travel time based on a zip code of a first node in a supply chain and a zip code of a second node in the supply chain; (b) receive a delivery schedule, the delivery schedule indicating the time of day that a product transport vehicle is scheduled to move product from the first node to the second node; (c) receive an unloading schedule, the unloading schedule indicating the time of day that the product transport vehicle is scheduled to be at the second node for the unloading of transported product; (d) receive a warehousing time estimate, the warehousing time estimate reflecting the amount of time spent in moving product out of the first node and the amount of time spent in moving the transported product into the second node; (e) receive product-node relationship data that identifies which products are located at the first node; and (f) calculate a lead time estimate for moving product from the first node in the supply chain to the second node in the supply chain based on the received route travel time estimate, the received delivery schedule, the received unloading schedule, the received warehousing time estimate, and the received product-node relationship data.

A further aspect of the present disclosure includes a method of generating a lead time between a first node and a second node of a supply chain. The method includes building a library of supplier performance; calculating item transfer transaction times; calculating warehouse processing times; pre-calculating lead times; receiving a lead time request at an application programming interface; generating lead time options for routes; receiving a selection of lead time options for shipping and fulfillment; and generating a calculated fulfillment time based on the selected lead time.

In another aspect, a computer implemented method of generating lead times for movement of one or more items from a first node to a second node is described. The method comprises: presenting a user interface on a display of a computing device, the user interface comprising: a source node field, a destination node field, a ship begin date field, and a ship end date field. Input is received of a source node, a destination node, and at least one of a ship begin date and a ship end date. At least one lead time option is calculated, the lead time option have a shipping method and rate. The at least one lead time option is presented on the user interface.

### BRIEF DESCRIPTION OF THE DRAWINGS

FIG. 1 illustrates a schematic diagram of an example supply chain for a retail enterprise.

FIG. 2 illustrates a schematic diagram of an example supply chain management system.

FIG. 3 illustrates a schematic diagram of a lead time architecture.

FIG. 4 illustrates a block diagram of an example computing device usable in the lead architecture of FIGS. 2-3.

FIG. 5 illustrates a detailed schematic diagram of a lead time calculation system.

FIG. 6 is a flow chart of an example method of determining and using lead time calculations within the supply chain management system of FIGS. 2-5.

FIG. 7 is an example table of lead time calculations.

FIG. 8A is an example user interface displaying fields for user input.

FIG. 8B is an example user interface displaying summaries of lead time options.

### DETAILED DESCRIPTION

Various embodiments will be described in detail with reference to the drawings, wherein like reference numerals represent like parts and assemblies through the several views. Reference to various embodiments does not limit the scope of the claims attached hereto. Additionally, any examples set forth in this specification are not intended to be limiting and merely set forth the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

Retailers and e-retailers have a continuing motivation to place the right type and quantity of products at the right location at the right time and price to achieve optimal sales. At least one factor to consider in achieving optimal sales through supply chain management is the lead time required to move product inventory through a supply chain to a final retail or e-retail destination. The methods and systems described herein provide a lead time architecture to calculate reliably accurate lead time estimates that can be used as a factor in supply chain management.

The lead time calculations of the present disclosure have a number of applications within the supply chain management system described herein. For example, the lead time calculations described herein can be used to calculate various alternative options for fulfillment scenarios in association with costs for such scenarios. This allows an enterprise to readily determine order fulfillment scenarios for various customers, while having an accurate, current view of inventory and lead times for providing that inventory to customers.

Lead time estimates are based on historical data. Events from purchase orders and receipts are ingested into event processor containers and are then stored in a sink. Lead time calculators then use actual data regarding the times it takes for items to be prepared for shipments and then travel from one node to another. This data is combined with estimates that are computer or human driven for how long it should take for an item to travel from one node to another. By incorporating projected estimates into the calculation, weak or slow nodes or shipping routes can be identified and improved.

The estimating process is automated to ingest information from multiple sources, where that information is constantly being updated in response to data from actual shipments. This automated process provides lead time estimates that can be accessed through an API by other services involved in supply chain management. By aggregating data from multiple sources, the lead time aggregator can quickly assess the amount of time that it will take an order to be completed with much greater speed and accuracy than previous systems. The automatic access to multiple data sources that are constantly being updated allows for a big picture calculation to be produced without individually accessing each source of data for each order or shipment scenario.

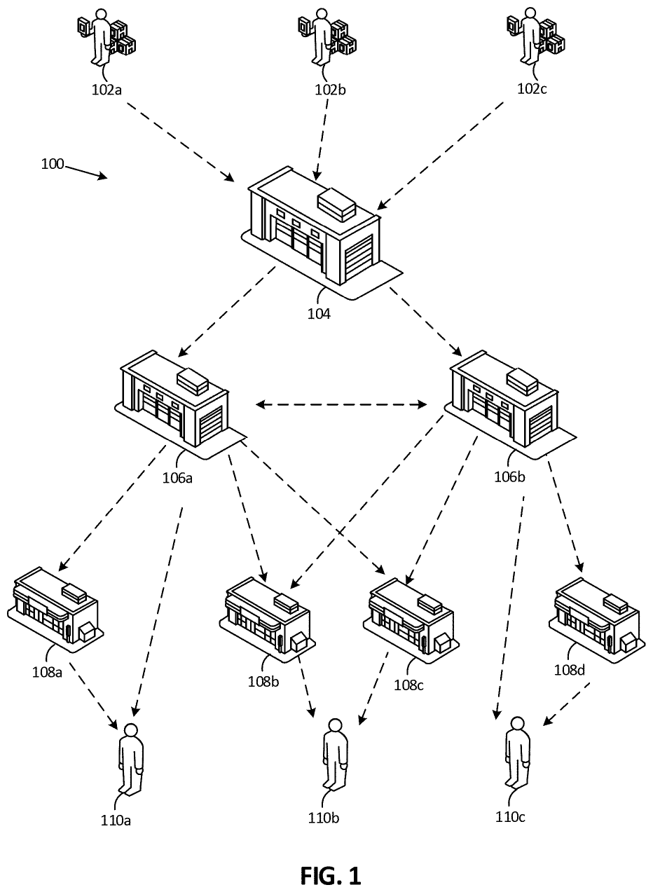

FIG. 1 illustrates a schematic diagram 100 of an example supply chain for a retail enterprise. This is just one example of a supply chain in which the present systems and methods can operate. The diagram 100 illustrates the flow of inventory from vendor 102 to customer 110. The inventory moves through various nodes to arrive at the customer. In this example, the nodes include a receive center 104, two flow centers 106a, 106b, four retail stores 108a, 108b, 108c, 108d, and three customer residences 110a, 110b, 110c. In practice, the supply chain could include many more nodes in different proportions. In some embodiments, there are not separate receive centers and flow centers. Instead, there may be one type of warehouse or distribution center for holding inventory before distributing to stores and customers.

Arrows in the diagram indicate movement of inventory. Inventory will typically flow downward through the supply chain, but in some instances inventory may move between flow centers 106 or between retail stores 108. In some embodiments, inventory may even move from a flow center 106 to a receive center 104 or from a retail store 108 to a flow center 106.

Vendors 102 produce/provide the items or products that will be sold by the retail entity. A purchase order is typically placed to request products from a vendor. In some instances, the vendor 102 will transport the ordered products to a receive center 104. In other instances, the retail entity arranges for the products to be picked up from the vendor 102 and transported to the receive center 104. Once at the receive center 104, the products are prepared for transportation to one or more flow centers. The products may arrive from the vendors in large groupings that need to be broken down into individual units for distribution to flow centers 106 and/or stores 108. Accordingly, once received into the supply chain of the enterprise, each individual unit can be tracked and shipped among the various nodes of the supply chain (receive centers 104, flow centers 106, and stores 108).

A variety of products are prepared for shipment to one or more flow centers 106. The flow centers 106 are typically positioned to enable quick shipment to one or more retail stores 108. Each flow center 106 may supply inventory to multiple retail stores 108. In some instances, more than one flow center 106 will send inventory to a retail store 108. For example, in FIG. 1, flow center 106a distributes inventory to stores 108a, 108b, and 108c. Flow center 106b distributes to stores 108b, 108c, and 108d. In some instances, to the extent products received at a flow center 106 are not already broken down into individual units, the products may be broken down into individual units in order to distribute individual items to stores 108, or optionally to fill online orders that will be delivered directly to customers from the flow center 106 or store 108. In the example of FIG. 1, products are shipped directly from flow center 106a to a customer 110a and from flow center 106b to customer 110c.

Once products arrive at the retail stores 108, they are either stored in a back room or displayed on shelves. This inventory is available for in-store purchases, pick-up orders, or local delivery. Depending on the location of a customer ordering products online, the shipments of products could come from one or more retail stores 108, or flow centers 106. For instance, customer 110b could receive shipments of products from either store 108b or store 108c, or both (in the instance of a multi-item purchase).

It is noted that, between receive centers 108, flow centers 106, and stores 108, there may be preexisting, predetermined delivery routes established. For example, there may be daily or weekly transit routes between a receive center and one or more flow centers. The receive center can provide to the flow centers the selection of individual items that are needed by stores 108 serviced by the one or more flow centers proximate to and/or servicing those stores. The flow centers can also have daily or other periodic transportation routes established to stores that are serviced, thereby ensuring prompt replenishment of items at stores in response to item sales.

In addition, the predetermined delivery routes can be used for various purposes. For example, in some situations, the predetermined delivery routes can be used to deliver products in various forms. As explained in further detail below, items distributed via the supply chain are tracked on an individual (per-item) basis; as such, items can be delivered to stores 108 in any convenient manner. In some example embodiments, items are tracked on an individual basis, but may be grouped at a flow center 106 to simplify restocking of the store 108, for example by placing together in a package a collection of individual items of different types but which may easily be stocked conveniently once those items arrive at a store 108. For example, goods that are located in a common department, row, or shelf of a store can be grouped and packed together at the flow center 106.

Once those items reach the store 108, a restocking operation can restock each of the items in that shelf, row, or department easily. Still further, because items are packed and tracked on an individual basis at the flow center and sent to stores based, at least in part, on demand signals received from stores, the item collections are based on the number of items sold and therefore the restocking operation can provide a package of items that will fit on store shelves, rather than requiring additional backroom stocking and storage.

In the context of the present disclosure, a supply chain management system is provided that assists in coordination of product shipments among nodes of the supply chain, and uses inventory models to automatically rebalance inventory within the supply chain of the enterprise to ensure predicted and actual item demand from customers of the enterprise is fulfilled to a predetermined threshold success rate. The supply chain management system allows for balancing of items across the supply chain based on inventory and demand models, as well as real time demand signals, and performs automated generation of purchase and transfer orders throughout the supply chain based on such demand and lead time calculations between paints both within and external to the supply chain. Accordingly, as noted below, substantial advantages are realized using the methods and systems of the present disclosure.

It is in this general supply chain retail environment that the following systems and methods operate. While the methods and systems are described in a retail environment having brick-and-mortar stores as well as online sales, additional applications are possible. For example, the systems and methods could operate in a supply chain of warehouses that only distribute products to customers in fulfillment of online orders. In other embodiments, the systems and methods could operate for distribution channels that distribute supplies to multiple locations within a business rather than selling to individual customers. Regardless of the application, the systems and methods described herein are most beneficial when used to manage a supply chain for a plurality of nodes with the goal of increasing efficiency of inventory movement by responding to both proactive and reactive demand signals in real time.

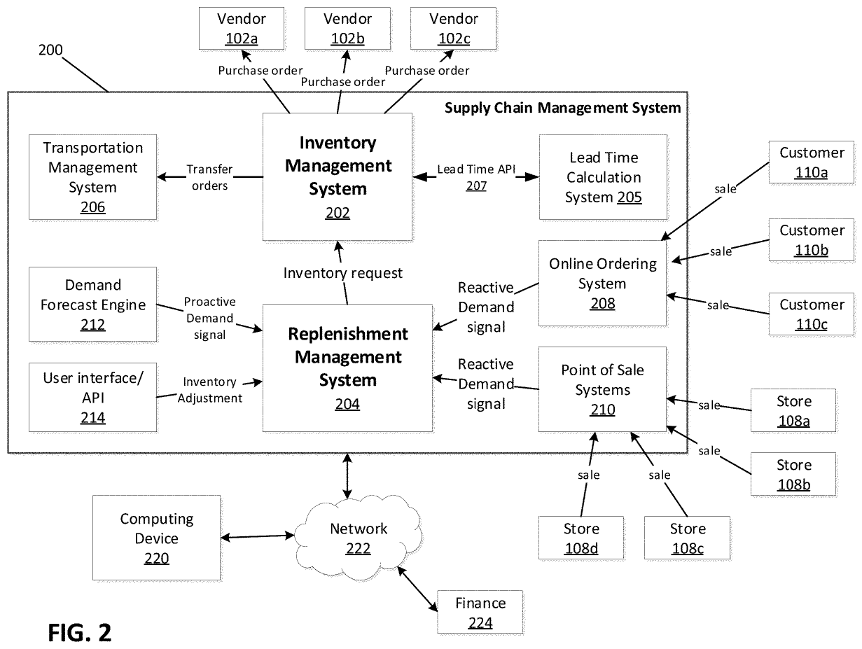

FIG. 2 illustrates a schematic diagram of an example system 200 for managing a supply chain. Components of the supply chain management system 200 include an inventory management system 202 and a replenishment management system 204. Together, the inventory management system 202 and replenishment management system 204 operate to monitor inventory levels across all nodes of a supply chain, determine if and when adjustments to inventory levels need to be made, and facilitate transport of inventory between nodes to respond to customer demand.

The inventory management system 202 receives inventory requests from the replenishment management system 204. In response to the inventory requests, the inventory management system 202 determines whether additional inventory is needed at one or more nodes within the supply chain to satisfy the request. Additional inventory may be transported to one node from another node if sufficient stock of the needed product(s) is available within the required timeframe within the supply chain. In such instances, transfer orders are issued to the transportation management system 206. If the inventory management system 202 determines that there is not sufficient stock of the requested products at another node or that transporting the products within the supply chain would be too costly or time consuming, additional stock is ordered from one or more vendors 102 through purchase orders issued from the inventory management system 202.

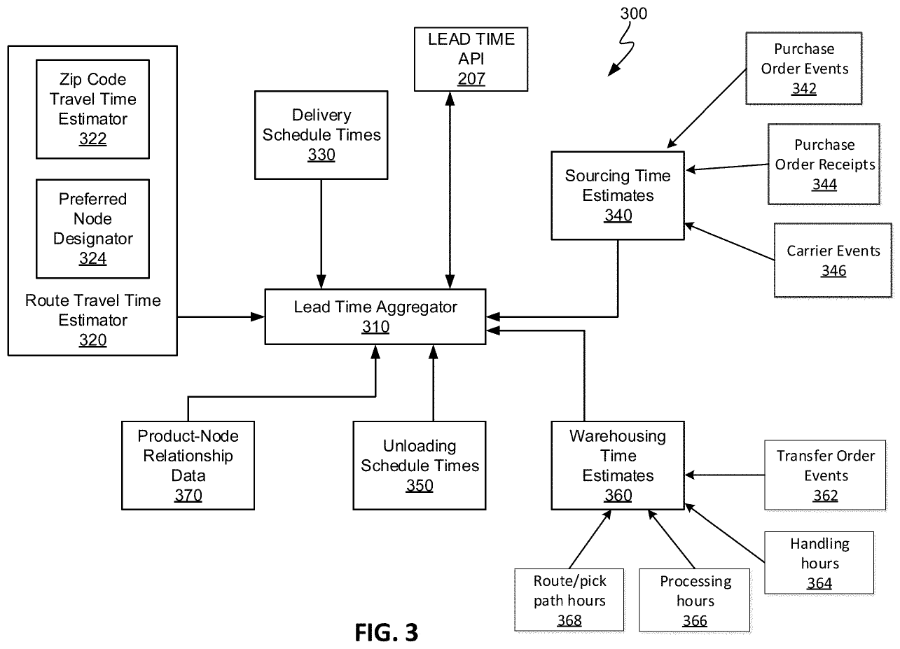

In particular, and in the embodiment shown, the supply chain management system 200 includes a lead time calculation system 205 that is operatively connected to the inventory management system 200. The lead time calculation system is described in further detail below in connection with FIG. 3; in general the lead time calculation system 205 publishes a lead time API 207 which can be queried by the inventory management system. The query provided to the lead time API 207 can include, for example, a starting point (e.g., a vendor, a receive center, a flow center, or a store) acting as a source of an item, and an end point (e.g., a receive center, flow center, store, or intended customer) for the item. The query can also include various additional parameters, for example restrictions regarding cost, prioritization (e.g., preferred or maximum lead time required for fulfillment), or shipping routes (e.g., air, land, vehicle type and class of shipment, etc.). In response, the lead time calculation system 205 generally can use aggregated transportation information and fulfillment timings (e.g., time to fulfillment of orders on a per-item or per-vendor basis) to determine a total lead time for fulfillment or replenishment of an item, or simply of movement of the item from point to point.

In the embodiment shown, the replenishment management system 204 receives demand signals from one or more sources including an online ordering system 208, one or more point of sale systems 210, and a demand forecast engine 212. The demand signals can be proactive or reactive. Proactive demand signals are received from the demand forecast engine 212 and are generated by predicting expected customer demand for individual products on a day by day basis. Reactive demand signals are received from the point of sale system 210 (e.g., a point of sale network distributed across stores 108 within the enterprise) or through the online ordering system 208. The online ordering system 208 receives orders from customers 110 and coordinates fulfillment of those orders. The point of sale systems 210 record sales that are made at stores 108. The replenishment management system 204 also receives inventory adjustments from the user interface 214. Inventory adjustments are instructions received from a user to modify inventory levels at one or more locations or nodes within the supply chain. Inventory adjustments may be made for reasons other than expected or actual customer demand for particular items.

In some embodiments the supply chain management system 200 communicates with a computing device 220 through a network 222. The network 222 can be any of a variety of types of public or private communications networks, such as the Internet. The computing device 220 can be any network-connected device including desktop computers, laptop computers, tablet computing devices, smartphones, and other devices capable of connecting to the Internet through wireless or wired connections. In some instances, the supply chain management system 200 also communicates with a finance system 224 through the network 222.

FIG. 3 illustrates a schematic diagram of an example lead time architecture 300. The lead time architecture 300 can be used, for example to implement the lead time calculation system 205 of FIG. 2. The lead time architecture includes a lead time aggregator 310 that is in wired or wireless communication with a plurality of data resources. The data resources can include any of various resources that can provide insight into the lead time needed to move a product between nodes, and/or from a vendor to a node, in the supply chain 100. In the example of FIG. 3, the data resources include a route travel time estimator 320, delivery schedule times 330, sourcing time estimates 340, unloading schedule times 350, warehousing time estimates 360 and product-node relationship data 370.

The route travel time estimator 320 utilizes a zip code travel time estimator 322 and a preferred node designator 324.

The zip code travel estimator 222 is able to provide travel time estimates between any two zip codes. In certain examples, the travel time estimates are calculated according to known distances, topography, speeds and/or other factors that can affect travel time. In other examples, the travel time estimates are supplied via a service provider such as PC*MILER™. PC*MILER specializes in providing transportation time and cost estimates associated with a distance and a desired number of stops between a point of origin and a point of final destination.

The preferred node designator 324 provides the preferred node path for transfer of product and is established through supply chain metrics. The identification of each node in the preferred path includes a zip code of the node.

The route travel time estimator 320 combines the zip codes of the nodes in the preferred product transfer path generated by the preferred node designator 324 with the data provided by the zip code travel estimator 322 to determine an estimated time of travel between each of the nodes in the preferred product transfer path. The node-to-node travel time estimates generated by the route travel time estimator 320 are provided to the lead time aggregator 310. In certain examples, the data from the zip code travel estimator 322 and the preferred node designator 324 can additionally be supplied to the lead time aggregator 310. In certain examples, the data from the from zip code travel estimator 322 and the preferred node designator 324 are supplied to the lead time aggregator 310 in place of the node-to-node travel time estimates provided by the route travel time estimator 320.

The delivery schedule times 330 comprise the times of the day that a product transport vehicle is scheduled to be moving product from one node to another node in the supply chain 100. The delivery schedule time data can be provided to the lead time aggregator 310 as static data based on pre-set transport schedules or can be provided in real time by monitoring movements of actual product transport vehicles.

The sourcing time estimates 340 reflect the estimated amount time required to manufacture, package, ship and deliver products to a node in the supply as measured from the receipt of a purchase order by a vendor. These estimates can be based on sourcing times of past purchase orders and/or on status notifications received during the sourcing process. The status notifications can include, for example, the date and time the vendor received and/or approved the purchase order, the date and time the manufacturing of the ordered product is complete, the date and time the product is packaged, the date and time the packaged product is placed with a carrier and the carrier's travel time in reaching a receive center 104 of the supply chain 100. Other factors affecting sourcing time may also be considered. The estimated sourcing time is provided to the lead time aggregator 310.

In certain examples, the estimated sourcing time can be overridden to reflect changes in standard sourcing procedures. For example, the vendor may deliver product to a flow center 106 and/or a retail store 108 rather than the receive center 104. The estimated sourcing time presumes delivery to the receive center 104 and, thus, delivery to a node other than a receive center 104 may shorten or lengthen the estimated sourcing time. This determined shortened or lengthened sourcing time can be provided to the lead time aggregator 310 as an override of the original estimated sourcing time.

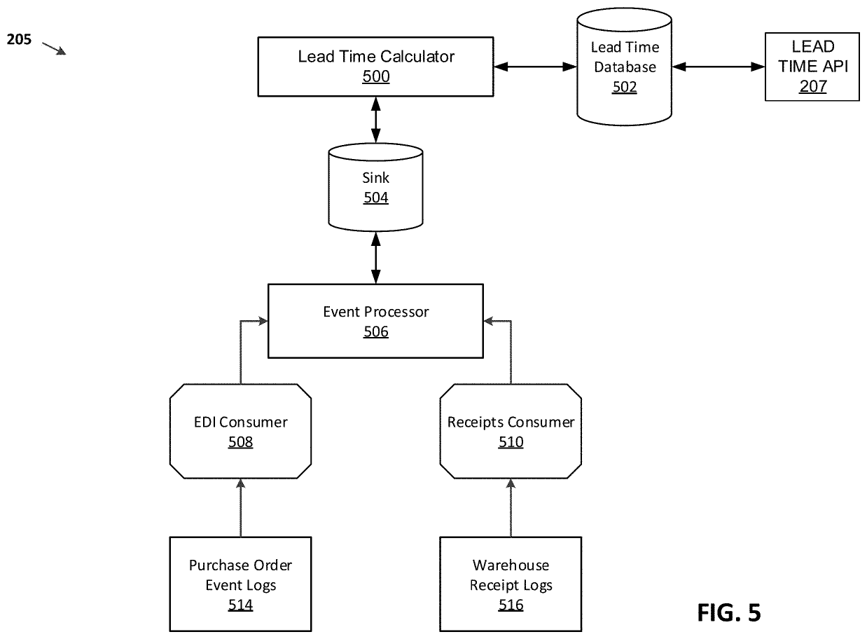

The sourcing time estimates 340 can be based on information coming from multiple events and receipts. In the example shown in FIG. 3, the source time estimates 340 are calculated based on purchase order events 342, purchase order receipts 344, and carrier events 346. Purchase order events 342 are generated, for example, by the inventory management system 202 of FIG. 2. Purchase order receipts 344 are received from the vendors 102 at the inventory management system 202. The inventory management system 202 also processes carrier events 346 received from the transportation management system 206. The inventory management system 202 communicates these events and receipts to the lead time calculation system 205 through the lead time API 207. Processing of events and receipts is described further in FIG. 5.

The unloading schedule times 350 comprise the times of the day and/or the amount of time that a product transport vehicle is scheduled to be at a node within the supply chain 100 for the purpose of unloading of products carried by the transport vehicle. The unloading schedule data can be provided to the lead time aggregator 310 as static data based on pre-set unloading schedules or can be provided in real time by monitoring the location of the product transport vehicle and the amount of time spent by the product transport vehicle at a node in the supply chain 100.

The warehousing time estimates 360 reflect the amount of time spent in moving product into and/or out of a node in the supply chain 100. The amount of warehousing time includes the time taken to handle the product at the node, e.g., the loading or unloading of product, the breakdown of product into smaller quantities, the packaging of product for transport, etc. The amount of warehousing time additionally includes the time needed to process all product entering or leaving the node, e.g. updating electronic inventory records to reflect the intake or removal of product from inventory. The amount of warehousing time further includes the time to place incoming product along a storage pick path enabling organized subsequent retrieval of the product and can also, or alternatively, include the time the to retrieve the product (e.g., via the storage pick path) for subsequent transport of product to another node in the supply chain 100. The warehousing times 360 are provided to the lead time aggregator 310. In certain examples, the warehousing time estimates can comprise a static estimate or can comprise real time updates, for example, by electronically tracking the movement of each product or group of like products throughout the warehousing processes.

The warehousing time estimates 360 can be calculated based on multiple sources of information. In the example of FIG. 3, the warehousing time estimates 360 are calculated based on transfer order events 362, handling hours 364, processing hours 366, and route/pick path hours 368. Transfer order events 362 are received and processed from the transportation management system 206. Event processing is further described in FIG. 5. Handling hours 364, processing hours 366, and route/pick path hours 368 are recorded at each warehouse. The hours can be recorded into a computing device manually or may be recorded automatically.

In certain examples, estimated warehousing times can be overridden to reflect changes in standard product warehousing procedures at a node. For example, a transfer order to move product from the current node to another node maybe received along with an instruction to delay transfer of the product for a specified time period. The delay in transfer of the product will include additional warehousing time that is not included in the original estimated warehousing time. As such, any shortening or lengthening of the estimated warehousing time can be provided to the lead time aggregator 210 as an override of the original estimated warehousing time for the transfer order.

The product-node relationship data 370 comprises data that identifies which products are located at which nodes, e.g. the in-stock inventory at the node. This data is provided to the lead time aggregator 310.

The lead time aggregator 310 takes in all data including the estimated time travel between nodes as provided by the route travel time estimator 320, product transport vehicle delivery schedules 330, estimated sourcing times (and/or overrides of sourcing times) 340, unloading schedules 350 of product transport vehicles, estimated warehousing times (and/or overrides of warehousing times) 360 and product-node relationships, to calculate an estimate of the total amount of lead time required to move a certain quantity of one or more types of products from a first node in the supply chain 100 to a second node in the supply chain 100 and/or to calculate an estimate of the total amount of lead time involved from placing a purchase order with a vendor to first receipt of the vendor product at a node within the supply chain 100. Note that a preferred node path for transport of product that includes more than two nodes can combine the lead times between each pair of nodes along the path to determine a lead time for the entire preferred node path.

Actual lead times as well as actual route travel times, sourcing times and warehousing times can be recorded to establish a database of historical data for comparison against estimates. The comparisons can be used to improve the estimates of route travel times, sourcing times, and warehousing as well as the overall lead time estimates calculated by the lead time aggregator 310. The ability to update historical data based on actual lead times results in highly accurate lead time estimates from the lead time aggregator 310 that can reliably persist within the supply chain 100. In certain examples, the lead time aggregator 310 is used to calculate a lead time estimate for a given date range based on historical data of lead times over a same or similar date range.

In some embodiments, the lead time aggregator 310 also utilizes expected values for travel time, sourcing time, and warehousing time. These values can be utilized to ensure that each node is performing as expected. If only historical data is utilized, a node that is performing too slowly would be accounted for in the calculations, but would not be held accountable for improving speed for moving inventory. Historical data can be utilized to inform expected values and make adjustments as needed.

As described above in connection with FIG. 2 and as seen in FIG. 3, the lead time aggregator 310 publishes an API that allows external services to form queries and obtain lead time estimates from the lead time aggregator based on each of the estimates, schedules, and calculations based on that data. As noted above, the lead time API can provide an interface to an external tool, for example to provide different lead time calculations based on preferred transportation routes, current and planned destination locations, and cost limitations. The API can also be accessed through a user interface accessible through a computing device, such as the computing device 220 of FIG. 2. Such information can be provided to the inventory management system 202, which can in turn compile current location information and item information to determine one or more shipment options and delivery dates for a particular item movement.

In some instances, for customer delivery, particular customers can be prioritized, allowing for faster (but likely more expensive) shipping options; in other instances, customer deliveries can be coordinated along store replenishment routes, thereby minimizing cost of shipping to the customer. Furthermore, via the API, the inventory management system 202 can calculate and determine likelihood of proper stock levels based on expected arrival times of items as determined by the lead time architecture. Other applications of lead time information accessible via the lead time API are possible as well.

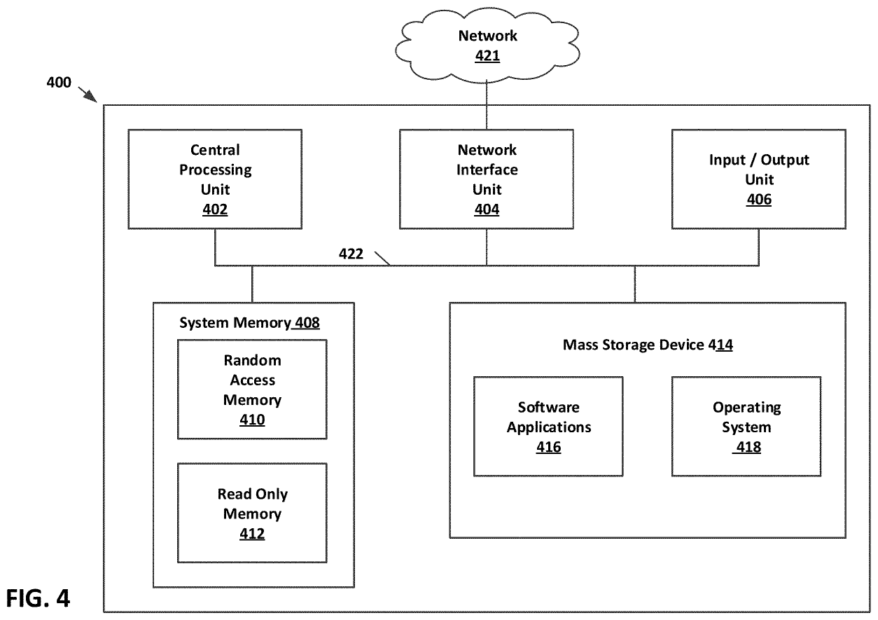

Referring now to FIG. 4, an example block diagram of a computing device 400 is shown that is useable to implement aspects of the lead time architecture 300 of FIG. 3. For example, the lead time aggregator 310 can comprise a computing device 400 in communication with one or more computing devices 400 serving as data resources (e.g. data resources 320, 322, 324, 330, 340, 350, 360 and/or 370). Additionally, the computing device 400 can be used to access the overall supply chain management system 200 as shown with the computing device 220 of FIG. 2.

In the embodiment shown, the computing device 400 includes at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system that contains the basic routines that help to transfer information between elements within the computing device 400, such as during startup, is stored in the ROM 412. The computing system 400 further includes a mass storage device 414. The mass storage device 414 is able to store software instructions and data such as those for executing the functions of the data aggregator 310 or data resources 320, 322, 324, 330, 340, 350, 360 and/or 370.

The mass storage device 414 is connected to the CPU 402 through a mass storage controller (not shown) connected to the system bus 422. The mass storage device 414 and its associated computer-readable storage media provide non-volatile, non-transitory data storage for the computing device 400. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 402 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing device 400.

According to various embodiments, the computing device 400 can operate in a networked environment using logical connections to remote network devices through a network 421, such as a wireless network, the Internet, or another type of network. The computing device 400 may connect to the network 421 through a network interface unit 404 connected to the system bus 422. It should be appreciated that the network interface unit 404 may also be utilized to connect to other types of networks and remote computing systems. The computing device 400 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the computing device 400 can store software instructions and data. The software instructions include an operating system 418 suitable for controlling the operation of the computing device 400. The mass storage device 414 and/or the RAM 410 also store software instructions, that when executed by the CPU 402, cause the computing device 400 to provide the functionality discussed in this document. For example, the mass storage device 414 and/or the RAM 410 can store software instructions that, when executed by the CPU 402, cause the computing system 420 to receive and analyze inventory and demand data.

Referring now to FIG. 5, a more detailed schematic diagram illustrating the lead time calculation system 205 is provided. The lead time calculation system 205 includes a lead time calculator 500 in communication with a lead time database 502. The lead time database 502 is accessible via the lead time API 207. An event processor 506 is in communication with the lead time calculator 500. The event processor 506 receives data regarding events from an EDI consumer 508 and a receipts consumer 510. The EDI consumer 508 receives purchase order event logs 518 and the receipts consumer 510 receives warehouse receipt logs 516.

In some embodiments, the purchase order event logs 518 and warehouse receipt logs 516 are sourced from Kafka event streams. The purchase order event logs 514 are received at the EDI consumer 508. The warehouse receipt logs 516 are received at the receipts consumer 510. The events in the logs are processed into containers for each type of event. The events are then processed at the event processor 506. In some embodiments, the events are temporarily stored in a sink 504 before being utilized by the lead time calculator 500. The sink 504 can include one or more of databases and Kafka Topics. The events can be stored until ready for use by the lead time calculator 500.

The lead time calculator 500 can calculate lead times in advance of their use. Such pre-calculated lead times are stored in the lead time database 502 until such time that they are requested by the lead time API 207.

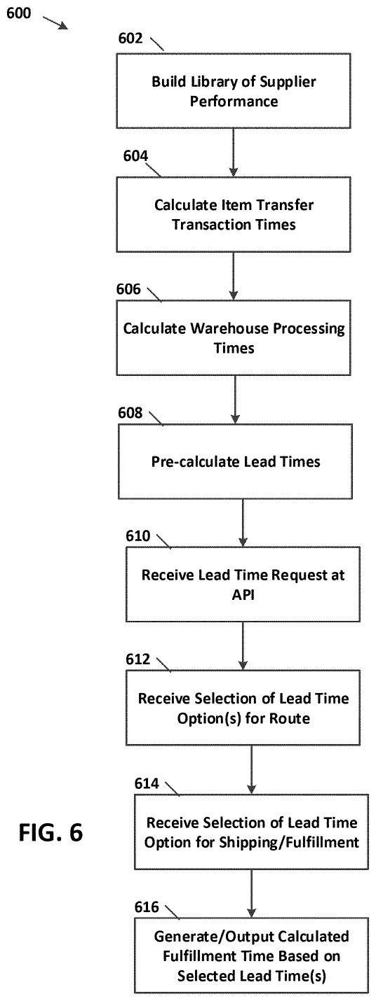

Referring now to FIG. 6, an example method 600 of performing and utilizing lead time calculations is described. The example method 600 can be performed, for example, using the supply chain management system 200 described above.

In the embodiment shown, at 602, the method 600 includes building a library of supplier performance metrics. This can include, for example, tracking times between order and product delivery from each of a plurality of suppliers, and maintaining such delivery timing information in a supplier database, for example in the sourcing time estimates 340 of FIG. 3. The supplier performance metrics library includes data aggregated from purchase order events 342, purchase order receipts 344, and carrier events 346.

At 604, item transfer transaction times are calculated. The item transfer transaction times can be determined between two locations within a supply chain network (e.g., between two receive centers, a receive center and a flow center, a flow center and a store, among stores/flow centers, or from any such location to a customer). This information can, for example be aggregated along with the known routes to generate travel time estimates, delivery schedule times, and various other movement times, as noted in FIG. 3. The information can be received and aggregated by an event processor 506 as described in FIG. 5.

At 606, warehouse processing times are calculated. The warehouse processing times can be determined based on events and receipts that are received at the event processor 506 before being ingested by the lead time calculator 500. Information relating to warehouse processing time includes transfer order events 362, handling hours 364, processing hours 366, and route/pick path hours 368.

At 608, lead times are pre-calculated. The lead time aggregator 310 ingests all of the relevant data to calculate a lead time between two different nodes. Some node-to-node lead times can be pre-calculated and stored in a lead time database such as the lead time database 502 of FIG. 5. These pre-calculated lead times can be accessed at any time through the lead time API 207. In other embodiments, lead times are only calculated upon receiving a request from the lead time API 207.

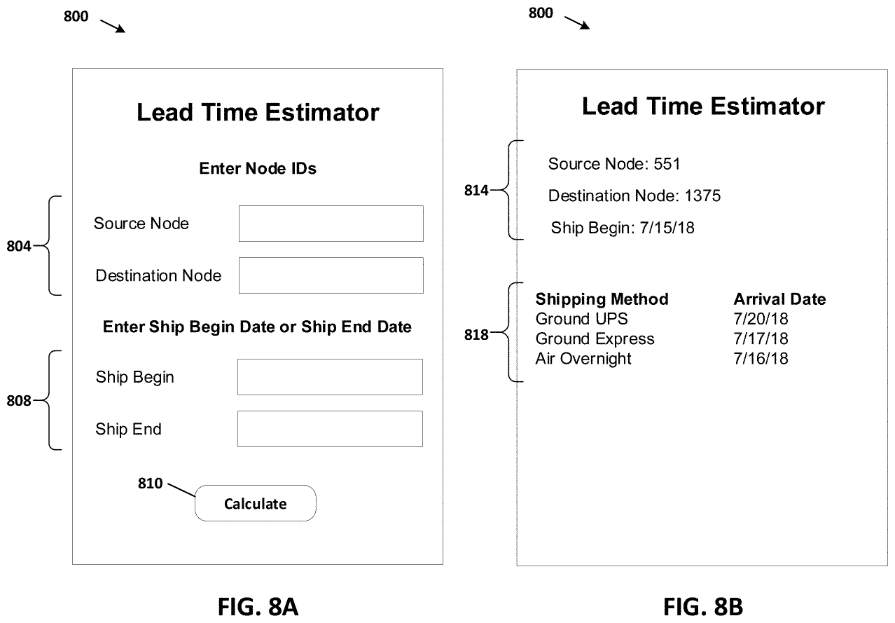

At 610, a request is received for a lead time estimate. The request can be received, for example, at a lead time API 207 of the lead time architecture 300 of FIG. 3. The request can include, for example, a starting point and an ending point within a supply chain. Selection of nodes can be performed through a user interface, such as the user interface 800 described in FIGS. 8A and 8B. The request can also include (optionally) preferred transit options. Such options include shipping speed and/or type.

At 612, at least one lead time option is selected and provided, e.g., via the API. In some embodiments, a plurality of lead time options are generated based on alternative routes and/or handling options. The lead time options can be generated by the lead time aggregator 310 of FIG. 1, and one or more of those lead time options can be provided via the lead time API. In some embodiments, the lead time options are displayed on a user interface and selections of options are received through the user interface. One example of such a user interface 800 is shown in FIGS. 8A-8B.

At 614, a lead time option is selected for the particular shipment/fulfillment operation to be performed (i.e., which was the subject of the request received at the API). Accordingly, at 616, a lead time is generated and optionally output via the API based on the selected lead time option, and based on the aggregated lead times for the particular selected starting and ending point(s). The lead time can be based, for example, on expected timing for each of the various transport, stocking, unloading, warehousing, sourcing, and delivery timing estimates aggregated using the lead time architecture of FIG. 3. The lead time can into account both historical data and expected values for timing.

In general, the supply chain architecture described herein can use the lead time generated according to the process of FIG. 5 in a variety of ways. For example, the supply chain architecture can calculate times for transport of items between points in the supply chain, and to determine when an item will be available at the particular location. This information can be delivered to users or used in replenishment and/or order fulfillment planning purposes.

The lead time values generated by the lead time calculation system 205 can be utilized by various components of the supply chain management system 200. For example, the timing of inventory adjustments from the user interface/API 214 or proactive demand signals from the demand forecast engine 212 can be adjusted according to calculated lead times. Accurate lead times allow for leaner stocking of warehouses and other nodes. If the lead times for restocking a node are accurate, the inventory request can be made only when additional stock is needed and there is less lag time between the request being made and the inventory being positioned where it is needed. Proper timing of replenishment ensures that sufficient stock of desired items will be available at each node without overstocking items and spending unnecessary resources on storing such items.

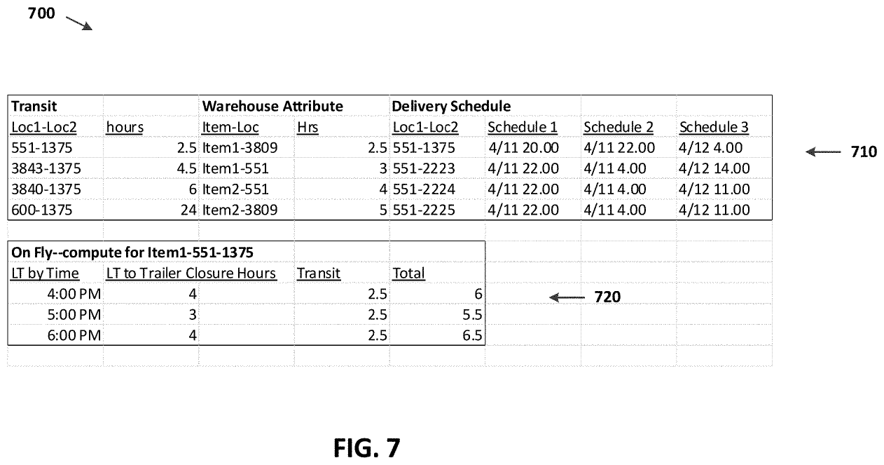

FIG. 7 illustrates an example table 700 of values that are utilized to calculate lead times. In sub-table 710, transit times, warehouse attributes, and delivery schedules are taken into account to calculate lead times for different pairs of nodes. In this example, each node pair includes node 1375 as the destination node. Each source node has a different transit time to the destination node 1375. Similarly, each location and item have different attributes that are taken into account for calculating lead times. Different delivery schedules are taken into account to produce three different estimated lead times.

Sub-table 720 shows calculations for on-the-fly lead times for item 1 being transported from node 551 to node 1375. Three different lead time calculations are shown for different times of day. The total lead times depend on the lead time to trailer closure hours and transit time.

Other examples of data structures and tables are possible for calculating and storing lead time values. In some examples, such data structures are incorporated into the lead time data base 502 of FIG. 5

FIGS. 8A and 8B illustrate an example user interface 800 that can be employed on a computing device such as the computing device 220 of FIG. 2. FIG. 8A shows a view of the user interface 800 presenting node fields 804. Input is received as selections or text input in the node fields 804 that specifies a first node and a second node. The nodes specify the source location and destination location of a particular shipment or transfer of items. The ship date fields 808 receive input specifying a data for at least one of a ship begin date and a ship end date. In some instances, only one date can be entered and the other date will be generated by the system. Once the node fields 804 and at least one ship date field 808 is filled, a selection of the calculate button 810 can be received to initiate calculation of lead time options.

The view of the user interface 800 in FIG. 8B shows a summary 814 of the entered information for source node, destination node, and ship begin date. Lead time options 818 are also presented for the nodes and the selected date. Three shipping options are shown with three different arrival dates. In some embodiments, this information could be automatically output to other systems within the supply chain management system 200. In other embodiments, a selection of a desired lead time option can be received through the user interface 800 to put a purchase order into motion within the inventory management system 202. A purchase order request can be initiated that includes the options selected for the lead time calculation.

It is noted that the lead time architecture described herein has a number of technical advantages over existing system, particularly when used in the context of a supply chain management system. In particular, by aggregating lead times and providing a flexible lead time architecture, the system can coordinate order replenishment with knowledge about lead times, which leads to specific computational and physical item movement efficiencies. For example, accurate lead time calculations, available in real-time, allow for accurate, real-time replenishment decisions to be made with less computational complexity—e.g., requiring additional tracking accuracy of or a last calculation time of lead times associated with a particular route. Also, accurate, aggregated leadtimes and an exposed API providing access thereto allows each other portion of the supply chain management system to access lead times, allowing for integration with, e.g., a consumer website, to provide accurate real-time fulfillment estimates to customers directly. This can lead to more informed purchase decisions as well, due to the computational efficiencies apparent within the supply chain management system.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1. A lead time estimating system comprises:
a processor; and
a memory device, the memory device containing instructions that when executed by the processor cause the processor to:
receive an estimated route travel time, the estimated route travel time based on a zip code of a first node in a supply chain and a zip code of a second node in the supply chain;
receive a delivery schedule, the delivery schedule indicating the time of day that a product transport vehicle is scheduled to move product from the first node to the second node;
receive an unloading schedule, the unloading schedule indicating the time of day that the product transport vehicle is scheduled to be at the second node for the unloading of transported product;
receive a warehousing time estimate, the warehousing time reflecting the amount of time spent in moving product out of the first node and the amount of time spent in moving the transported product into the second node;
receive product-node relationship data that identifies which products are located at the first node; and
calculate a lead time estimate for moving product from the first node in the supply chain to the second node in the supply chain based on the received route travel time estimate, the received delivery schedule, the received unloading schedule, the received warehousing time, and the received product-node relationship data, the lead time estimate being accessible through an application programming interface by a supply chain management system.

2. The lead time estimating system of claim 1, wherein the instructions further cause the processor to receive a sourcing time estimate and calculate an estimate for a lead time in sourcing a product that includes the time between receipt of a purchase order by a vendor and the time of delivery of the ordered product to the first or second node within the supply chain.

3. The lead time estimating system of claim 1, wherein the instructions further cause the processor to receive, at a lead time generator, a request identifying at least the first node and the second node.

4. The lead time estimating system of claim 3, wherein the request further identifies one or more shipping preferences.

5. The lead time estimating system of claim 3, wherein the request is received via an application programming interface exposed to an inventory control system.

6. The lead time estimating system of claim 1, wherein the lead time estimate is based at least in part on a priority shipping option.

7. The lead time estimating system of claim 6, wherein the priority shipping option is associated with a customer.

8. The lead time estimating system of claim 1, wherein the first node comprises one of a vendor, a receive center, a flow center, or a store.

9. The lead time estimating system of claim 1, wherein the second node comprises one of a receive center, a flow center, a store, or a customer location.

10. The lead time estimating system of claim 1, wherein calculating a lead time estimate further comprises receiving at least one of an expected route travel time, an expected sourcing time, and an expected warehousing time.

11. A method of generating a lead time between a first node and a second node of a supply chain, the method comprising:
building a library of supplier performance;
calculating item transfer transaction times;
calculating warehouse processing times;
pre-calculating lead times;
receiving a lead time request at an application programming interface;
generating lead time options for routes;
receiving a selection of lead time options for shipping and fulfillment; and
generating a calculated fulfillment time based on the selected lead time.

12. The method of claim 11, further comprising outputting the lead time estimate to an inventory management system via an application programming interface.

13. The method of claim 11, further comprising outputting the lead time estimate to a user interface via an application programming interface.

14. The method of claim 12, further comprising generating one or more transfer orders based on a replenishment plan generated at the inventory management system based at least in part on the lead time calculation.

16. The method of claim 11, further comprising receiving, at a lead time generator, a request identifying at least the first node and the second node.

17. The method of claim 11, wherein building a library of supplier performance metrics further comprises receiving input of expected supplier performance metrics.

18. The method of claim 17, wherein the input is received from one of a user and a machine.

19. A computer implemented method of generating lead times for movement of one or more items from a first node to a second node, the method comprising:
presenting a user interface on a display of a computing device, the user interface comprising:
a source node field,
a destination node field,
a ship begin date field, and
a ship end date field; and
receiving input of a source node, a destination node, and at least one of a ship begin date and a ship end date;
calculating at least one lead time option, the lead time option have a shipping method and rate; and
presenting the at least one lead time option on the user interface.

20. The computer implemented method of claim 19, further comprising receiving a selection of a lead time option and initiating a purchase order request in according with the select lead time options.
